(19) United States
(12) Patent Application Publication
(10) Pub. No.: US 2014/0298962 A1
(43) Pub. Date: Oct. 9, 2014

(54) ELASTIC AVERAGING ALIGNMENT SYSTEM, METHOD OF MAKING THE SAME AND CUTTING PUNCH THEREFOR

(71) Applicant: GM GLOBAL TECHNOLOGY OPERATIONS LLC, Detroit, MI (US)

(72) Inventors: Steven E. Morris, Fair Haven, MI (US); Jennifer P. Lawall, Waterford, MI (US); Joel Colombo, Howell, MI (US); Jeffrey L. Konchan, Romeo, MI (US)

(73) Assignee: GM Global Technology Operations LLC, Detroit, MI (US)

(21) Appl. No.: 13/855,928

(22) Filed: Apr. 3, 2013

(51) Int. Cl. B26F 1/14

(52) U.S. Cl. CPC B26F 1/14
USPC 83/13; 83/686; 83/821

(57) ABSTRACT

An elastic averaging alignment system includes a first component comprising a surface, a thickness and a plurality of elastically deformable apertures spaced apart on the surface and extending through the thickness, each of the elastically deformable apertures comprising an aperture peripheral shape and having at least one slit extending radially-outwardly therefrom defining at least one elastically deformable wedge member. A method of making a component alignment system includes providing a first component having a surface and a thickness. The method also includes forming a plurality of alignment features through the thickness of the first component, the alignment features comprising a plurality of elastically deformable apertures spaced-apart on the surface and extending through the thickness, each of the elastically deformable apertures comprising an aperture peripheral shape and having at least one slit extending radially-outwardly therefrom defining at least one elastically deformable wedge member.

### FIELD OF THE INVENTION

The subject invention relates to an elastic averaging alignment system and method for use with compliant materials and to the art of cutting punches and, more particularly, to cutting punches for use in forming elastic averaging features in compliant materials.

### BACKGROUND

There exist numerous systems for aligning two or more components. In some cases, one component will include alignment pins, threaded rods, or other similar projecting structures. The projecting structures are configured to be received by oversized openings in a second component to facilitate a desired alignment. Generally, there exists a need to maintain tolerances between the projecting structure and corresponding openings sufficient to achieve the desired alignment of the components, including both two-way and four-way alignment. Using these alignment systems, misalignments may be magnified and tolerances may stack-up when the first member includes two or more spaced-apart projecting structures and alignment is required with a corresponding number of openings. While existing systems enable relative alignment of the components by allowing sufficient relative movement, the engagement of the alignment features (i.e., insertion of the protruding features in the holes) does not provide a predetermined alignment of the components, but only allows relative movement by an operator, tool, gauge or the like to obtain their desired alignment. Accordingly, it is desirable to provide an alignment system that incorporates alignment features that provide a desired alignment between the components.

### SUMMARY OF THE INVENTION

In accordance with an exemplary embodiment, a cutting punch is disclosed. The cutting punch includes a central punching member, the central punching member comprising a cutting end, the cutting end having a peripheral shape. The cutting punch also includes at least one cutting element extending radially outwardly from the central punching member, the at least one cutting element having a cutting edge.

In accordance with another exemplary embodiment, a method of making a component alignment system is disclosed. The method includes providing a first component having a surface and a thickness. The method also includes forming a plurality of alignment features through the thickness of the first component, the alignment features comprising a plurality of elastically deformable apertures spaced-apart on the surface and extending through the thickness, each of the elastically deformable apertures comprising an aperture peripheral shape and having at least one slit extending radially-outwardly therefrom defining at least one elastically deformable wedge member.

In accordance with yet another exemplary embodiment, an elastic averaging alignment system is disclosed. The alignment system includes a first component comprising a surface, a thickness and a plurality of elastically deformable apertures spaced apart on the surface and extending through the thickness, each of the elastically deformable apertures comprising an aperture peripheral shape and having at least one slit extending radially-outwardly therefrom defining at least one elastically deformable wedge member.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of an embodiment of an elastic averaging cutting punch and cutting punch die in accordance with an exemplary embodiment;

FIG. 2A is a top plan view of the cutting end of the elastic averaging cutting punch of FIG. 1;

FIG. 2B is a cross-sectional view of section 2B-2B of FIG. 2A;

FIG. 3 is a perspective view of an embodiment of a motor vehicle trim element including a plurality of elastically deformable apertures, each having a plurality of radially extending slits formed by the elastic averaging cutting punch of FIG. 1;

FIG. 4 is a top plan view of the cutting end of a second embodiment of an elastic averaging cutting punch;

FIG. 5 is a top plan view of the cutting end of a third embodiment of an elastic averaging cutting punch;

FIG. 6 is a top plan view of region A of FIG. 3;

FIG. 7A is an embodiment of an elastically deformable aperture having one radially extending slit and one elastically deformable wedge;

FIG. 7B is an embodiment of an elastically deformable aperture having two radially extending slits and two elastically deformable wedges;

FIG. 7C is an embodiment of an elastically deformable aperture having three radially extending slits and three elastically deformable wedges;

FIG. 7D is an embodiment of an elastically deformable aperture having four radially extending slits and four elastically deformable wedges; and

FIG. 8 is a section view of an elastically deformed aperture according to section 8 of FIG. 6 having a rigid member inserted therein and elastically deforming the aperture.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

An alignment system that utilizes alignment features comprising elastically deformable apertures is disclosed. The elastically deformable apertures may be used with a rigid member, such as various rigid cylindrical pins, including hollow or solid pins, or spheres, to provide elastic averaging for precision location and alignment of all manner of mating components and component applications, including many industrial, consumer product (e.g., consumer electronics, various appliances, furniture and the like), transportation, energy and aerospace applications, and particularly including many types of vehicular components, including those utilizing compliant materials, such as all manner of liners, including headliners, trunk liners, door liners, dash liners, instrument panel liners, flooring, upholstery, including seating and other upholstered components, seals, including various door, trunk, sun roof, moon roof, dash and other elastomeric seals, sound damping materials and the like. The compliant materials may have any suitable forms, including various two-dimensional forms, such as sheets and pads, as well as various three-dimensional forms, such as molded parts having all manner of shapes that may be configured, whether by the use of various flanges or other positioning and alignment features, to utilize the positioning and alignment system described herein.

This invention uses a punch configured for use in compliant materials that furnishes an aperture and one or more wedges in the compliant material that will elastically adjust (i.e. elastically deform) when a pin, sphere, or other rigid mating feature is inserted into the aperture. The punch provides cuts or slits that radiate from an aperture in the form of a hole or slot and that comprise elastically deformable wedges which furnish elastic averaging capabilities within a compliant material. Incorporation of at least one aperture with the radiating slits, and preferably a plurality of apertures with the radiating slits, allows precision alignment between two mating components without additional tooling (i.e., using a single punch design). The aperture and the elastically deformable wedges are configured to interfere with a feature or features of the mating part or member that is substantially rigid (i.e., not elastically deformable) relative to the aperture and wedges. The over-constrained interfaces (i.e. due to the interference) will average each individual positional error of each elastically averaged aperture. These elastically averaged alignment features allow elastic averaging within a component formed from a compliant material and may provide for better coverage and fit of many compliant components, for example, increased perimeter coverage for various acoustic materials and seals, or reduced seal sizes due to improved precision of the seal location (i.e. not having to oversize a seal due to potential positional variation associated with its placement).

As the components are assembled the elastically deformable wedges that define the apertures are elastically deformed. The deformable wedges comprise cantilevered beam portions of the respective component. These cantilevered beams are elastically deformed, either by radial compression of the ends of the beams against the peripheries of the rigid members upon their insertion into the apertures, or a mode of radial, axial and/or circumferential bending of the deformable wedges as they are pressed against the rigid members, or a combination thereof, that creates interference conditions that elastically average the positional variations associated with the aperture/pin alignment features and provide a four-way locating scheme, since the rigid members may press against the apertures radially outward in any radial direction (i.e. 360°). Furthermore, the over-constrained interfaces of the rigid members will elastically deform each of the cantilevered beam wedges on each side of the mating apertures to an extent or degree that averages the individual positional error of each aperture. Elastic averaging provides elastic deformation of the interface(s) between mated components, wherein the average deformation provides a precise alignment, the manufacturing positional variance being minimized to Xₘᵢₙ, defined by Xₘᵢₙ=X√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in detail in commonly owned, co-pending U.S. patent application Ser. No. 13/187,675, the disclosure of which is incorporated by reference herein in its entirety. The embodiments disclosed herein provide the ability to convert an existing component that is not compatible with the elastic averaging principles described herein to an assembly that does facilitate elastic averaging and the benefits associated therewith.

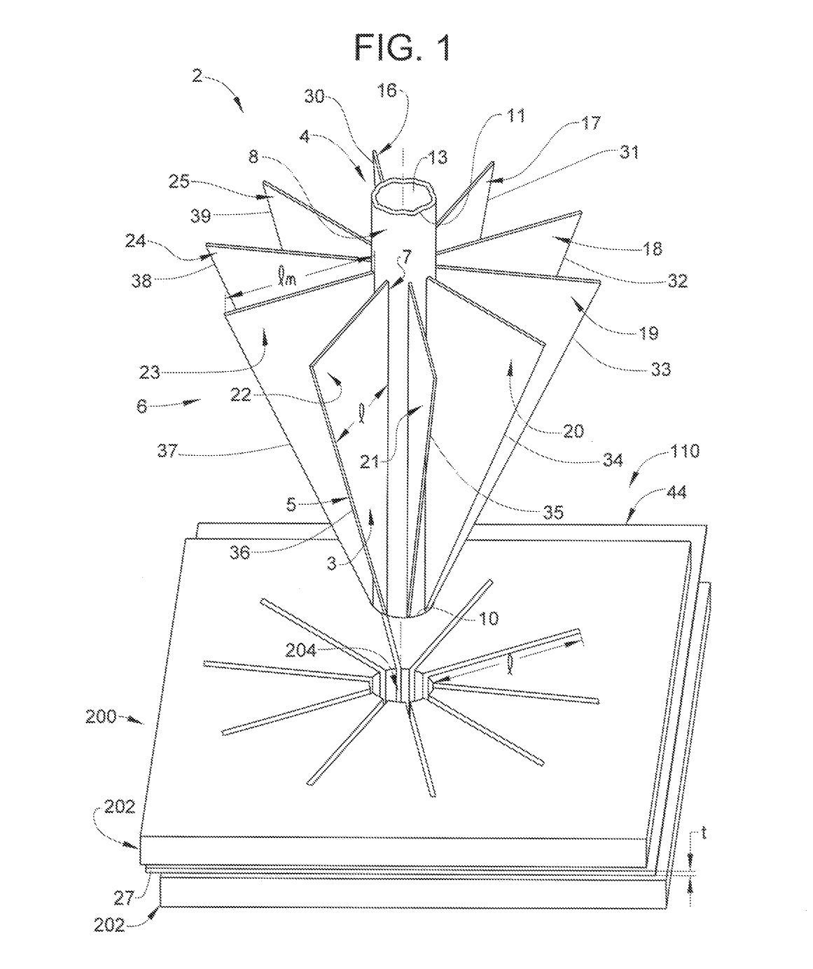

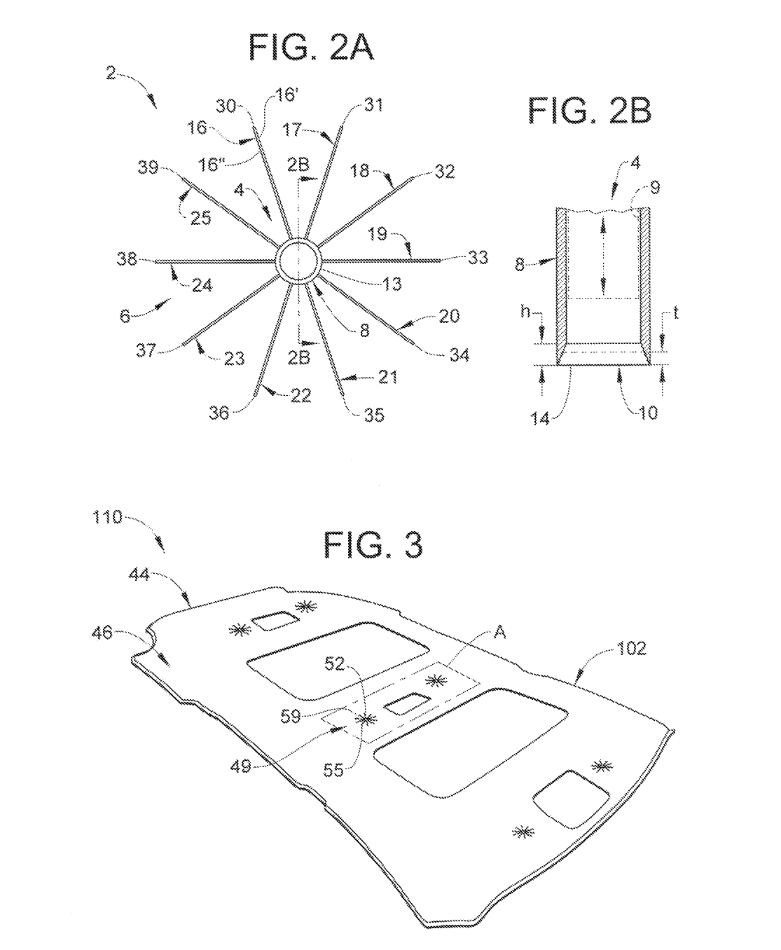

Referring generally to FIGS. 1, 2A and 2B, an elastic averaging cutting punch in accordance with an exemplary embodiment is indicated generally at 2 in FIGS. 1 and 2A. Elastic averaging cutting punch 2 includes a central punching member 4 that supports a plurality of radially outwardly extending, circumferentially spaced, tapered cutting elements or cutters 6. Each of the cutting elements 6 have an attachment side 7 that is configured for one of detachable or fixed attachment to the punching member 4 that extends axially along the longitudinal axis 12. Each of the cutting elements 6 also has a tapered body 3 and a cutting edge 5 that tapers outwardly away from the central punching member 4. Central punching member 4 includes a body 8 that extends from a first end or cutting end 10 toward a second end 11. The cutting edges 5 taper outwardly away from the central punching member 4 from the cutting end 10 toward the second end 11. The cutting end 10 and the cutting edges 5 may be configured in any suitable cutting edge configuration, including all manner of conventional knife edge configurations. In accordance with the exemplary embodiment shown, the body 8 includes a substantially circular cross-section 13. As shown in FIG. 2B, in one embodiment, the cutting end 10 has a tapered cutting edge 14. The tapered cutting edge 14 may extend to a height (h) that is greater than the thickness (t) of the material 27 to be punched. In the embodiment of FIGS. 1-2B, the body 8 of the punching member 4 may include a central bore 15 proximate the cutting end 10 the central bore 15 may be configured to receive a mechanism for ejecting the punched material 27 that is excised by the punching member 4 as it is used as described herein, such as, for example, an axially slidable ejector 9 or a flow of compressed air that may be selectively released to eject the punched material 27 that is excised by the punching member 4. The cutting punch member 4 may also be used with a punch die 200 that has one or more die members 202 that include a die aperture 204 that is configured to receive the punch member 4 in close fitting engagement. The die members 202 may also be configured to compress the material 27 to be punched between them to maintain its flatness during the punching process. The punching member 4, including the cutting elements 6, and punch die 200 may be made from any suitable material, including various metals, and more particularly various steel alloys, such as various high strength, high fracture toughness tool steel alloys.

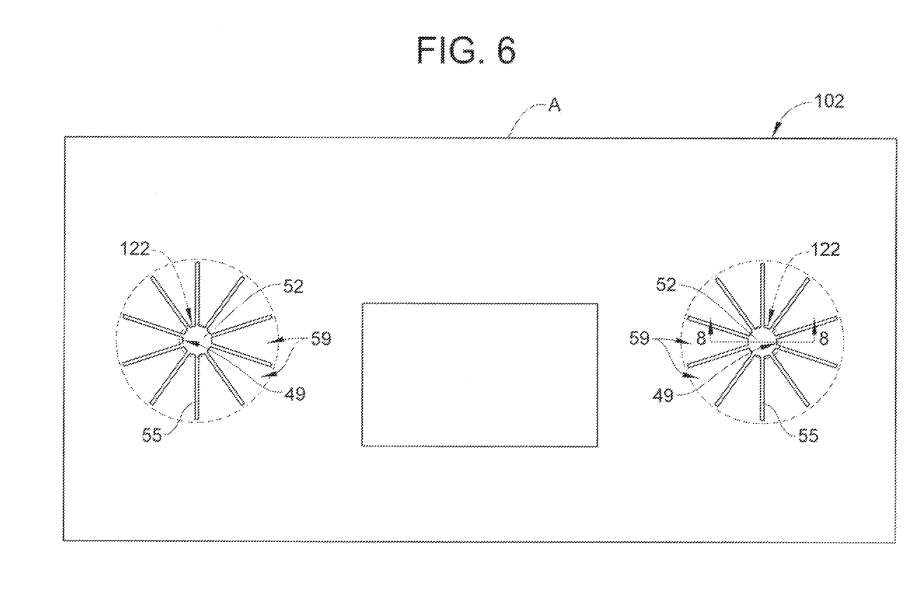

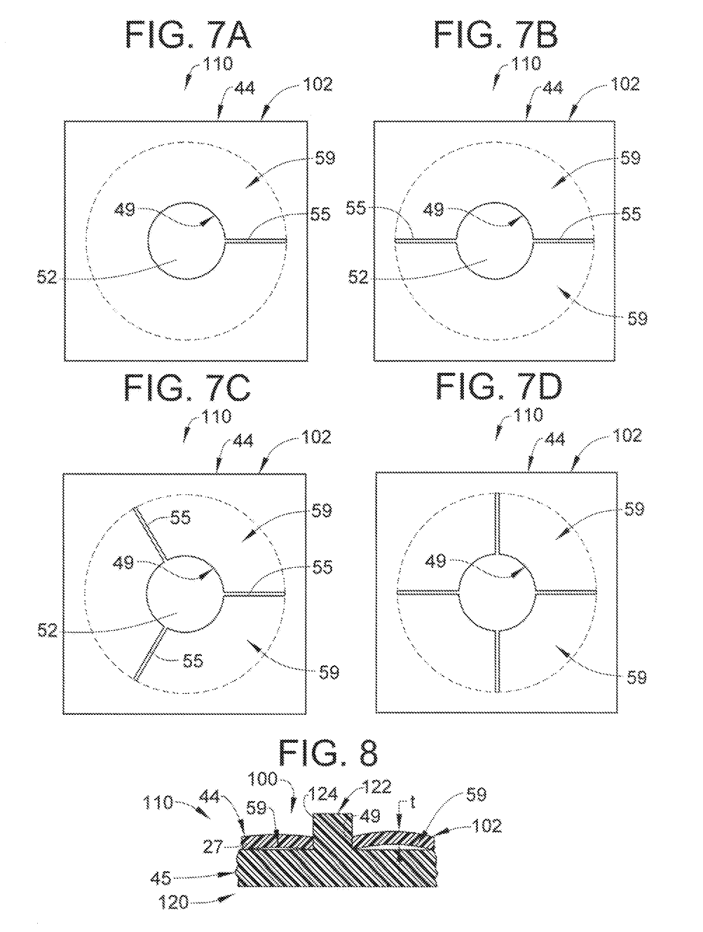

In accordance with an exemplary embodiment of the invention, the plurality of cutting elements 6 include a first cutting member 16, a second cutting member 17, a third cutting member 18, a fourth cutting member 19, a fifth cutting member 20, a sixth cutting member 21, a seventh cutting member 22, an eighth cutting member 23, a ninth cutting member 24, and a tenth cutting member 25. Cutting elements 16-25 extend radially outwardly from central punching member 4 and have substantially planar surfaces, such as, for example, substantially planar surfaces 16′ and 16″ (FIG. 2A), and are arrayed about body 8 with a circumferential or peripheral (in the case of bodies 8 with non-circular cross-sections) spacing. The spacing may be any suitable spacing including various uniform and non-uniform spacings. In accordance with one aspect of the exemplary embodiment, cutting elements 16-25 are detachably mounted to body 8, such as by employing various keyway or dovetail joint configurations. However, it should be understood that cutting elements 16-25 may also be materially integrally formed with body 8, such as by being cast as a unitary member, or may be fabricated by welding the cutting elements 6 to the body 8. Each cutting member 16-25 includes a corresponding radially outward cutting edge 30-39. Radially outward cutting edges 30-39 taper outwardly away from the central punching member 4 from the cutting end 10 toward the second end 11. The taper of cutting edges 30-39 may be linear as shown or curvilinear, such as various convex (outwardly away from the body) or concave (inwardly toward the body) configurations. Any suitable number of cutting elements 6 may be employed. In one embodiment, the number of cutting elements 6 may range from 1 to 14 and more particularly from 2-12, and even more particularly from 3-10, and most particularly 4-8. The size and shape of the periphery of the cutting end 10 may be selected to define a predetermined shape and size of the apertures and the number of cutting elements 6 and size and shape of the cutting edges 5 may be selected to provide a predetermined number of deformable wedges and their size (as illustrated in FIGS. 6 and 7A-7D by the phantom lines that define the wedges), including the length (1) of the slits that define them. The length (l) of the slits is defined by the size of the cutting elements 6, including the maximum radial length (lₘ) and the extent of the axial insertion of the cutter into the material 27 of the first component 102. The elastic deformation characteristics of the wedges, and the cantilevered beams that they define, are determined by the number and size of the wedges, as well as the thickness (t) of the material 27 in which they are formed and its physical and mechanical properties, particularly its elastic modulus as shown in FIG. 8. All of these aspects of the wedges may be selected to provide a predetermined response characteristic of the cantilevered beams. The cutting elements 6 may be the same and provide slits that have the same length (l) or may be different, including being configured to provide slits that have a different length. The cutting elements 6 may be spaced circumferentially on the central punching member 4 in any suitable manner, including symmetrically or asymmetrically. For various circular and non-circular aperture configurations, the cutting elements 6 may be positioned and arranged so that they extend substantially orthogonally away from the portion of the tapered cutting edge 14 with which they are associated.

Referring to FIGS. 3, 6 and 8, in accordance with an exemplary embodiment, elastic averaging cutting punch 2 may be employed to form one or more elastic averaging apertures 49 for use in connection with an alignment system 100 for a first component 102 and a second component 120. The first component 102 may be a component of any suitable assembly or device, including those components described herein. In one embodiment, the component 102 comprises a component of a motor vehicle. For example, the first component 102 may include a motor vehicle trim element 44, shown in the form of a head liner member 46 in FIGS. 3 and 6. The first component 102 includes at least one and preferably a plurality of elastic averaging apertures or openings 49. As shown in FIG. 8, the elastic averaging apertures 49 are configured to receive substantially rigid (not elastically deformable) members 122 formed on the second component 120 in locations that correspond to the apertures 49, including rigid solid or hollow tubular pins 124 or spheres (not shown). In FIG. 6, the locations of the rigid members 122 are shown such that they are not concentric with apertures 49 representing the types of positional variation of the apertures/rigid members as may exist in the respective first component 102 and second component 120 as a result, for example, of their respective manufacturing processes and as may be averaged using the alignment system 100. FIG. 8 illustrates the result upon insertion of the rigid members 122 into the apertures 49 where one deformable wedge member 59, namely the one on the right as viewed in the figure, is deformed to a greater extent than the deformable wedge member on the left to accommodate the positional variation of the centers of the rigid member 122 and the aperture 49. The second component 120 may be a head liner attachment base 45 of a motor vehicle. The particular form of elastic averaging apertures 49 provides positioning and alignment of the head liner member 46 and the headliner base 45 as the plurality of apertures 49 of the head liner member 46 are inserted onto the rigid members 122 of the head liner base 45, such as by an operator/installer, to achieve a desired final fit and finish. More specifically, each elastic averaging aperture 49 includes a central opening 52 formed by central punching member 4 and a plurality of slits or slices 55 formed by cutting elements 16-25. Slits 55 define a plurality of elastically averaging wedge members 59. With this arrangement, central opening 52 may receive and elastically average a rigid member 122 to provide a predetermined alignment thereof using wedge members 59.

The material 27 used to form the first component 102 may be any suitable compliant material. Depending on the thickness of the material 27 and the size and shape of the wedges, suitable materials may include various metals, thermoplastic polymers, thermoset polymers, woven and non-woven fabrics, or composites, or combinations thereof. Metals may include various metal sheets, including steel alloy and aluminum alloy sheets. Thermoplastic polymers and thermoset polymers may include various elastomers thereof, including natural and synthetic rubbers and silicones. Composites may include various polymer/fiber or fabric composites, or polymers that include other fillers, such as various particulate fillers, or combinations thereof.

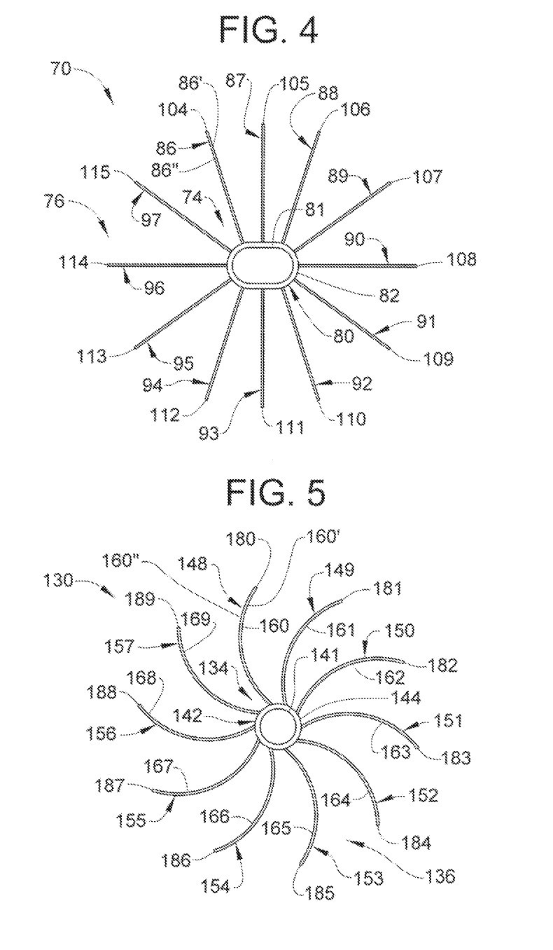

Referring to FIG. 4, in another exemplary embodiment, an elastic averaging cutting punch 70 includes a central punching member 74 that supports a plurality of cutting elements 76. The central punching member 74 includes a body 80 having a non-circular cross-section 82 and a tapered cutting edge 81 similar to that described for the embodiment of FIGS. 2A-2B. In the exemplary embodiment shown, the non-circular cross-section is generally oval, but other curved or polygonal shapes, or combinations thereof, are possible. In a manner similar to that described above, the plurality of cutting elements include a first cutting member 86, a second cutting member 87, a third cutting member 88, a fourth cutting member 89, a fifth cutting member 90, a sixth cutting member 91, a seventh cutting member 92, an eighth cutting member 93, a ninth cutting member 94, a tenth cutting member 95, an eleventh cutting member 96 and a twelfth cutting member 97. The cutting elements 86-97 extend radially outwardly from the central punching member 74 and are arrayed about the body 80 and have substantially planar surfaces, such as, for example, substantially planar surfaces 86′ and 86″. In accordance with one aspect of the exemplary embodiment, cutting elements 86-97 are detachably mounted to body 80 as described herein. However, it should be understood that the cutting elements 86-97 may also be materially integrally formed with the body 80 as described herein. Each cutting member 86-97 includes a corresponding radially outward cutting edge 104-115. Radially outward cutting edges 104-115 may taper along body 80 in any manner as described herein.

Referring to FIG. 5, in another exemplary embodiment, an elastic averaging cutting punch 130 is disclosed. The elastic averaging cutting punch 130 includes a central punching member 134 that supports a plurality of cutting elements 136. The central punching member 134 includes a body 142 having a substantially circular cross-section 144 and a tapered cutting edge 141 similar to that described for the embodiment of FIGS. 2A-2B. In a manner similar to that described above, the plurality of cutting elements 136 include a first cutting member 148, a second cutting member 149, a third cutting member 150, a fourth cutting member 151, a fifth cutting member 152, a sixth cutting member 153, a seventh cutting member 154, an eighth cutting member 155, a ninth cutting member 156, and a tenth cutting member 157. Cutting elements 148-157 extend radially outwardly from central punching member 134 and are substantially uniformly arrayed about body 142. In accordance with one aspect of the exemplary embodiment, cutting elements 148-157 are detachably mounted to body 142 as described herein. However, it should be understood that cutting elements 148-157 may also be materially integrally formed with body 142 as described herein. Each cutting member 148-157 includes a corresponding substantially curvilinear surface 160-169 and a radially outward cutting edge 180-189. Each of the curvilinear surfaces, such as curvilinear surface 160 includes a generally concave side 160′ and a generally convex side 160″. The plurality of curvilinear surfaces 160-169 may be curved in any suitable manner, including as a plurality of substantially circular arcs. Radially outward cutting edges 180-189 taper along body 142 while generally curvilinear surfaces 160-169 create an aperture having slits that spiral outwardly away therefrom.

An elastic averaging cutting punch in accordance with the exemplary embodiments may be used to form elastic averaging apertures 49 that establish a predetermined alignment of one member relative to another. In other words, the alignment system 100 described herein provides an alignment of the first component 102 and second component 120 to a predetermined position relative to one another where they may be fastened or fixed to one another by any suitable attachment device (not shown), such as all manner of mechanical fasteners, such as screws and the like, or attachment mechanism (not shown), including various adhesive members (e.g. adhesive tapes) or adhesive materials that may be applied to the first component 102 or second component 120.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A cutting punch, comprising:
a central punching member, the central punching member comprising a cutting end, the cutting end having a peripheral shape; and
at least one cutting element extending radially outwardly from the central punching member, the at least one cutting element having a cutting edge.

2. The cutting punch of claim 1, wherein the central punching member and at least one cutting element are configured to punch a compliant material and form an aperture having the peripheral shape and at least one radially-outwardly extending elastic averaging wedge member.

3. The cutting punch of claim 1, wherein the cutting punch comprises a plurality of cutting elements.

4. The cutting punch of claim 1, wherein the cutting end of the central punching member is hollow and comprises an end wall that defines the peripheral shape.

5. The cutting punch of claim 1, wherein the peripheral shape of the central punching member comprises a substantially circular shape or a non-circular shape.

6. The cutting punch of claim 5, wherein the non-circular shape comprises an elongated oval shape.

7. The cutting punch of claim 1, wherein the at least one cutting element comprises a curved surface.

8. The cutting punch of claim 1, wherein the at least one cutting element comprises a planar surface.

9. The cutting punch of claim 1, wherein the at least one cutting element is detachably mounted to the central punching member.

10. A method of making a component alignment system, comprising:
providing a first component having a surface and a thickness;
forming a plurality of alignment features through the thickness of the first component, the alignment features comprising a plurality of elastically deformable apertures spaced-apart on the surface and extending through the thickness, each of the elastically deformable apertures comprising an aperture peripheral shape and having at least one slit extending radially-outwardly therefrom defining at least one elastically deformable wedge member.

11. The method of claim 10, wherein forming comprises:
providing a cutting punch, comprising:
a central punching member, the central punching member comprising a cutting end, the cutting end having the aperture peripheral shape; and
at least one cutting element extending radially outwardly from the central punching member, the at least one cutting element having a cutting edge; and
punching the component at a plurality of locations on the surface to form the plurality of elastically deformable apertures.

12. The method of claim 11, further comprising:
providing a second component having a second surface, the second component comprising a plurality of spaced-apart protruding members that protrude from the second surface, each of the protruding members having a protruding member peripheral shape, the spaced-apart protruding members corresponding to the spaced-apart, elastically deformable apertures and configured for mating engagement therein, the protruding member peripheral shape being larger than the aperture peripheral shape and configured to elastically deform the elastically deformable member upon mating engagement therein; and
inserting the protruding members into the elastically deformable apertures in mating engagement, wherein the protruding members elastically deform the elastically deformable apertures and establish a predetermined position of the first component relative to the second component.

13. The method of claim 12, wherein at least one of the first component or the second component comprise a component of a vehicle headliner.

14. An elastic averaging alignment system, comprising:
a first component comprising a surface, a thickness and a plurality of elastically deformable apertures spaced apart on the surface and extending through the thickness, each of the elastically deformable apertures comprising an aperture peripheral shape and having at least one slit extending radially-outwardly therefrom defining at least one elastically deformable wedge member.

15. The alignment system of claim 14, further comprising a second component having a surface, the second component comprising a plurality of spaced-apart protruding members that protrude from the surface, each of the protruding members having a protruding member peripheral shape, the spaced-apart protruding members corresponding to the spaced-apart, elastically deformable apertures and configured for mating engagement therein, the protruding member peripheral shape being larger than the aperture peripheral shape and configured to elastically deform the elastically deformable member upon mating engagement therein.

16. The alignment system of claim 14, wherein the first component comprises a component of a vehicle headliner.

17. The alignment system of claim 14, wherein the aperture peripheral shape has a plurality of peripherally-spaced slits extending radially-outwardly therefrom defining a plurality of deformable wedge members.

18. The alignment system of claim 14, wherein the aperture peripheral shape comprises a substantially circular shape or non-circular shape.

19. The alignment system of claim 14, wherein the radially-outwardly extending at least one slit is substantially linear or curved.

20. The alignment system of claim 14, wherein the first component comprises a metal, thermoset polymer or thermoplastic polymer, or a combination thereof.
